(19) United States
(12) Patent Application Publication
(10) Pub. No.: US 2021/0167947 A1
(43) Pub. Date: Jun. 3, 2021

(54) SYSTEM AND METHOD FOR PROCESSING SECRET SHARING AUTHENTICATION

(71) Applicant: ELECTRONICS AND TELECOMMUNICATIONS RESEARCH INSTITUTE, Daejeon (KR)

(72) Inventors: Byung Ho CHUNG, Daejeon (KR); Sae Hoon KANG, Daejeon (KR); Ji Soo SHIN, Daejeon (KR); Nam Seok KO, Daejeon (KR); Sun Mi KIM, Daejeon (KR)

(73) Assignee: ELECTRONICS AND TELECOMMUNICATIONS RESEARCH INSTITUTE, Daejeon (KR)

(21) Appl. No.: 17/107,205

(22) Filed: Nov. 30, 2020

(30) Foreign Application Priority Data
Nov. 28, 2019 (KR) 10-2019-0156132

(51) Int. Cl. H04L 9/08; H04L 9/32

(52) U.S. Cl. CPC H04L 9/085; H04L 2209/046; H04L 9/0819; H04L 9/3213

(57) ABSTRACT

Disclosed herein is a system for a secret sharing authentication. The system may include a secret sharing information management server, a client device, and a network device. The secret sharing information management server may store and manage an authentication key capable of being used for secret sharing authentication, by dividing the authentication key into a first secret sharing key shard and a second secret sharing key shard, and allocate the first and second secret sharing key shards. The client device may receive the first secret sharing key shard from the secret sharing information management server and construct an interest packet by using the first secret sharing key shards. The network device may receive the second secret sharing key shard from the secret sharing information management server, and process the interest packet received from the client device on the basis of an ICN(Information Centric Networking) method by performing secret sharing authentication using the second secret sharing key shard and the first secret sharing key shard comprised in the interest packet.

### CROSS REFERENCE TO RELATED APPLICATION

The present application claims priority to 10-2019-0156132, filed Nov. 28, 2019, the entire contents of which are incorporated herein for all purposes by this reference.

### BACKGROUND OF THE INVENTION

### Field of the Invention

The present disclosure relates to an authentication processing technique and, in particular, to a method and apparatus for processing sharing authentication in an information-centric network environment.

### Description of the Related Art

Researches for realizing an in-networking processing technique in an information-centric network (ICN) environment are actively conducted by IETF COINRG and other organizations.

The in-networking processing technique is a type of network-distributed computing that utilizes a computing resource of a network communication device like a router for a computation offloading service. When a user's device (for example, IoT terminal) requests operation processing to a network, a random in-network device, which is dynamically selected in a routing/forwarding process, processes the request and responds to the user's device by sending a corresponding result.

In such an environment, securing a cryptographic authentication means, which prevents an unauthorized user from illegally occupying or abusing computing resources of network-distributed processing devices, is very important to provide a safe in-networking processing service.

According to the traditional authentication method, a server and a user share secret information in advance, and the secret information is verified between the server and the user when the user accesses a network device. In this case, the server is a verifier, and the user is a prover. Most of the conventional internet authentication methods have a “1 verifier-u provers” structure. One authentication server (verifier) at the center verifies a multiplicity of (u) users (provers). On the other hands, in-network authentication has a “n verifiers-u provers” structure. Each of N network devices (verifiers), which are independent of each other, verifies each of u users (provers).

In such a structure, that is, in an in-network distributed processing environment with characteristics of “1-way, low-delay, dynamic selection of an in-network processing device, and division operation processing”, the conventional technique has the following limitations.

First, regarding to the 1-way, the information-centric network provides a 2-way request-response communication protocol without concept of session. When an in-network processing device (verifier) receives a prover (user)'s request, an immediate authentication, that is, 1-way authentication is required. On the other hand, the conventional technique requires 3-way or 4-way handshaking, thereby causing not only authentication traffic but also a problem of authentication session management.

Second, regarding to the low-delay, the information-centric network aims for a low-delay communication service. An in-network processing device (verifier) demands local authentication whereby a user's request is immediately authenticated on the spot. A remote authentication method that sends a query to a central server for authentication causes not only an increase of delay time but also a problem of traffic load.

Third, regarding to the dynamic selection, an in-network device (verifier) is dynamically determined according to a routing/forwarding strategy. In such an environment, the authentication method of a prior art need to manage authentication databases of u provers at every processing device, synchronization the authentication databases, and maintain the authentication databases. This is inapplicable to a communication device. Accordingly, a new authentication method is necessary which can identify and authenticate a user without requiring a device (verifier) to maintain user information.

Fourth, regarding to the division operation processing, the in-network processing device may divide a user's operation request into sub operations and request processing sub operations to a new in-network processing device. Here, a “user-device operation processing chain” is generated. Authentication is necessary which may provide connectivity between a prover (user or current processing device) and a verifier (new processing device) in an operation processing chain. However, a challenge-response authentication method of a prior art cannot provide such authentication.

### SUMMARY OF THE INVENTION

To address the above-discussed deficiencies, it is a primary object to provide a method and apparatus for an in-network threshold secret sharing authentication and key distribution implementing such features as 1-way authentication, dynamic sharing authentication, low-delay local authentication, division operation-connected authentication.

Also, the present disclosure aims to provide a method and apparatus for processing threshold secret sharing authentication in an ICN environment.

The technical objects of the present disclosure are not limited to the above-mentioned technical objects, and other technical objects that are not mentioned will be clearly understood by those skilled in the art through the following descriptions.

According to one aspect of the present disclosure, a system for a secret sharing authentication may be provided. The system may include a secret sharing information management server, a client device, and a network device. The secret sharing information management server may store and manage an authentication key capable of being used for secret sharing authentication, by dividing it into a first secret sharing key shard and a second secret sharing key shard, and allocate the first and second secret sharing key shards. The client device may receive the first secret sharing key shard from the secret sharing information management server and construct an interest packet by using the first secret sharing key shards. The network device may receive the second secret sharing key shard from the secret sharing information management server, and process the interest packet received from the client device on the basis of an ICN(Information Centric Networking) method by performing secret sharing authentication using the second secret sharing key shard and the first secret sharing key shard comprised in the interest packet.

The features briefly summarized above with respect to the present disclosure are merely exemplary aspects of the detailed description below of the present disclosure, and do not limit the scope of the present disclosure.

### BRIEF DESCRIPTION OF THE DRAWINGS

FIG. 1 is a block diagram illustrating a system for a secret sharing authentication according to an embodiment of the present disclosure.

FIG. 2 is a diagram illustrating a concept of secret sharing authentication according to an embodiment of the present disclosure.

FIG. 3 is a diagram illustrating an operation of a secret sharing authentication system according to an embodiment of the present disclosure.

FIG. 4A is a diagram illustrating an initial setting operation of a secret sharing information management server in the system, according to an embodiment of the present disclosure.

FIG. 4B and FIG. 4C are diagram illustrating detailed operations of the step S420 of FIG. 4A.

FIG. 5A is a diagram illustrating an operation of registering a client device in the system, to a secret sharing information management server, according to an embodiment of the present disclosure.

FIG. 5B is a diagram illustrating an operation of registering a network device in the system, to a secret sharing information management server, according to an embodiment of the present disclosure.

FIG. 6 is a diagram illustrating an operation of distributing secret sharing key shards by a secret sharing information management server in the system, according to an embodiment of the present disclosure.

FIG. 7 is a view illustrating that a network device installed in a secret sharing authentication system sets defaults for threshold secret sharing authentication according to an embodiment of the present disclosure.

FIG. 8 is a view illustrating that a client device installed in a secret sharing authentication system requests an in-network processing service by using a secret sharing authentication token, according to an embodiment of the present disclosure.

FIG. 9 is a view illustrating an interest packet used in a secret sharing authentication system according to an embodiment of the present disclosure.

FIG. 10 is a view illustrating that an in-network service is requested and processed by using a secret sharing authentication token in a secret sharing authentication system according to an embodiment of the present disclosure.

FIG. 11 is a view illustrating an authentication operation where a network device installed in a secret sharing authentication system uses a secret sharing authentication token, according to an embodiment of the present disclosure.

FIG. 12A is a view illustrating that a network device, which is installed in a secret sharing authentication system, constructs and transmits an interest packet for split-operation, according to an embodiment of the present disclosure.

FIG. 12B is a view illustrating an interest packet generated by the operation of FIG. 12A.

FIG. 13A is a view illustrating that a network device, which is installed in a secret sharing authentication system, sends a split operation result, according to an embodiment of the present disclosure.

FIG. 13B is a view illustrating a response data packet generated by the operation of FIG. 13A.

FIG. 14 is a block diagram illustrating a computing system for executing an apparatus and method for processing information of multiple cameras and an apparatus and method for a secret sharing authentication according to an embodiment of the present disclosure.

### DETAILED DESCRIPTION OF THE INVENTION

Hereinbelow, exemplary embodiments of the present disclosure will be described in detail with reference to the accompanying drawings such that the present disclosure can be easily embodied by one of ordinary skill in the art to which this invention belongs. However, the present disclosure may be variously embodied, without being limited to the exemplary embodiments.

In the description of the present disclosure, the detailed descriptions of known constitutions or functions thereof may be omitted if they make the gist of the present disclosure unclear. Also, portions that are not related to the present disclosure are omitted in the drawings, and like reference numerals designate like elements.

In the present disclosure, when an element is referred to as being “coupled to”, “combined with”, or “connected to” another element, it may be connected directly to, combined directly with, or coupled directly to another element or be connected to, combined directly with, or coupled to another element, having the other element intervening therebetween. Also, it should be understood that when a component “includes” or “has” an element, unless there is another opposite description thereto, the component does not exclude another element but may further include the other element.

In the present disclosure, the terms “first”, “second”, etc. are only used to distinguish one element, from another element. Unless specifically stated otherwise, the terms “first”, “second”, etc. do not denote an order or importance. Therefore, a first element of an embodiment could be termed a second element of another embodiment without departing from the scope of the present disclosure. Similarly, a second element of an embodiment could also be termed a first element of another embodiment.

In the present disclosure, components that are distinguished from each other to clearly describe each feature do not necessarily denote that the components are separated. That is, a plurality of components may be integrated into one hardware or software unit, or one component may be distributed into a plurality of hardware or software units. Accordingly, even if not mentioned, the integrated or distributed embodiments are included in the scope of the present disclosure.

In the present disclosure, components described in various embodiments do not denote essential components, and some of the components may be optional. Accordingly, an embodiment that includes a subset of components described in another embodiment is included in the scope of the present disclosure. Also, an embodiment that includes the components described in the various embodiments and additional other components are included in the scope of the present disclosure.

Hereinafter, embodiments of the present disclosure will be described with reference to the accompanying drawings.

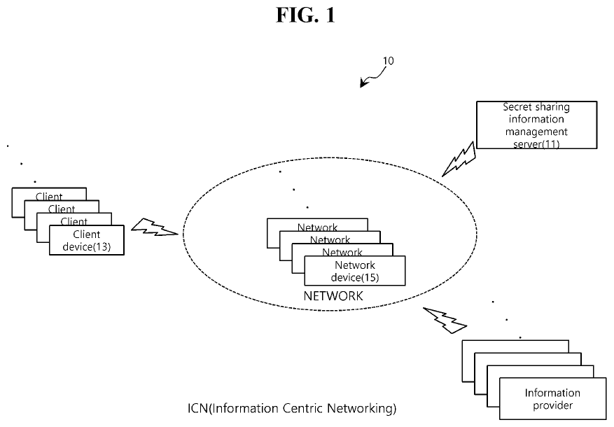

FIG. 1 is a block diagram showing a secret sharing authentication system according to an embodiment of the present disclosure.

Referring to FIG. 1, a secret sharing authentication system 10 according to an embodiment of the present disclosure may perform authentication in an ICN (Information

Centric Networking) environment and include a secret sharing information management server 11, a client device 13 and a network device 15.

The secret sharing information management server 11 may manage and divide a secret key capable of being used for secret sharing authentication into secret sharing key shards. Particularly, a secret sharing authentication system 10 according to an embodiment of the present disclosure may be constructed in an in-networking processing environment. In order to implement threshold secret sharing, secret sharing key shards may be configured by dividing a secret key according to the number (n) of processing devices installed in the secret sharing authentication system 10, and may also be possessed by being allocated to each processing device. Thus, each processing device installed in the secret sharing authentication system 10 may independently perform authentication or verification without intervention of a central server during the authentication process. Based on this, the secret sharing information management server 11 may generate and mange an available pool of secret sharing key shards that are to be allocated to each processing device, that is, the client device 13 and the network device 15, which are installed in the secret sharing authentication system 10. In addition, the secret sharing information management server 11 may receive a request of secret sharing information from the client device 13 or the network device 15 and may also allocate and provide secret key shards in an available pool.

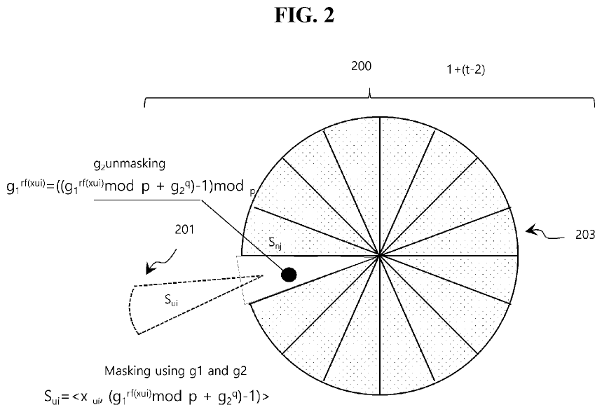

Furthermore, in the secret sharing authentication system 10, a client device may function as a prover requesting authentication, and the network device 15 may function as a verifier verifying the requested authentication. Thus, in the secret sharing authentication system 10, u provers, that is, u client devices 13 are installed, n verifiers, that is, n network devices 15 are installed, and one secret sharing information management server 11 is installed. In addition, the secret sharing information management server 11 is so constructed that a secret key 200 (refer to FIG. 2) can be divided according to u client devices 13 and n network devices 15 (201, 203).

The client device 13 may be an apparatus that generates and transmits an interest packet in an ICN environment. Particularly, the client device 13 may request a key sharing key shard to the secret sharing information management server 11 and construct a secret sharing authentication token including a secret sharing key shard 201 received from the secret sharing information management server 11. In addition, the client device 13 may generate an interest packet including a secret sharing authentication token.

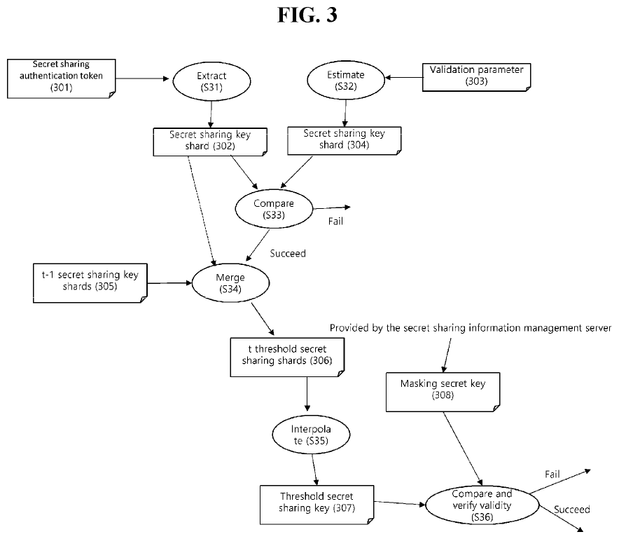

The network device 15 is an apparatus that receives an interest packet from the client device 13 in an ICN environment and transmits the packet to an information provider. A network device may include a router. Particularly, the network device 15 may request a key sharing key shard 203 to the secret sharing information management server 11 and store the secret sharing key shard 203 received from the secret sharing information management server 11. In addition, the network device 15 may confirm a secret sharing authentication token included in an interest packet and perform secret sharing authentication. Particularly, the network device 15 may extract a secret sharing key shard 302 included in a secret sharing authentication token 301 (refer to FIG. 3) of an interest packet (S31) and also estimate a secret sharing key shard 304 of the client device 13 by using a validation parameter 303 (S32). In addition, the network device 15 may verify validity for an extracted secret sharing key shard 302 provided by the client device 31 by comparing an estimated secret sharing key shard 304 with the secret sharing key shard 302 (S33). In addition, the network device 15 may make t threshold secret sharing shards 306 by merging a secret sharing key shard 302 of the verified client device 13 with t-1 secret sharing key shards 305, which are set by an initial operation, and may reconstruct a threshold sharing secret key 307 by using Lagrange interpolation (S35). In addition, the network device 15 may verify the validity of a threshold sharing secret key 307 by comparing a reconstructed threshold sharing secret key 307 and a making secret key 308 received from a server (S36). Consequently, the network device 15 may process a verification operation for a secret sharing key shard 302 of the client device 13 by receiving a validation parameter 303, t-1 secret sharing key shards 305 and a masking secret key 308 from the secret sharing information management server 11, estimating a secret sharing key shard 304 by using received information (S32), constructing t threshold secret sharing shards 306 (S34), and performing interpolation of a threshold sharing secret key 307. Thus, since verification process is not concentrated in the secret sharing information management server 11 and the network device 15 is so constructed as to process a verification operation by using information received from the secret sharing information management server 11, distributed verification may be efficiently performed by using resources included in the network device 15, while information necessary for verification is not leaked to an external device.

Furthermore, in case a split operation is required for secret sharing authentication, the network device 15 may request split operation processing to another network device and process a split operation by receiving a result.

Hereinafter, detailed operations of a secret sharing authentication system 10 will be described in detail.

<Initial Settings of Secret Sharing Information Management Server>

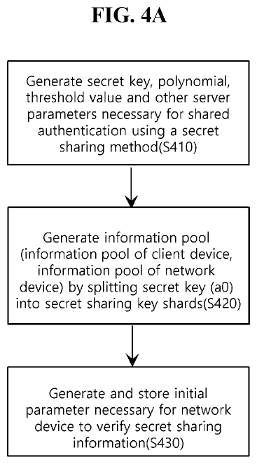

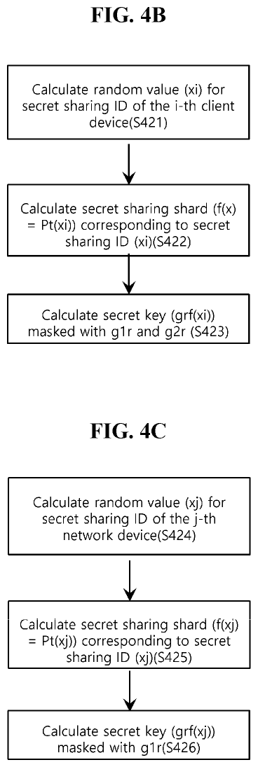

FIG. 4A to FIG. 4C are views illustrating an initial setting operation of a secret sharing information management server installed in a secret sharing authentication system according to an embodiment of the present disclosure.

Referring to FIG. 4A, the secret sharing information management server 11 may generate secret sharing information and store and mange it in a pool.

Specifically, the secret sharing information management server 11 may generate server parameters necessary for distributed authentication using secret sharing methods like a secret key, a polynomial and a threshold (S410). A secret sharing polynomial may be expressed by Equation 1 below.

P^{t}(x)=a₀+a₁x+a₂x²+. . . +aₜx^{t} Equation 1

Here, a coefficient may be [a₀, a₁, . . . , aₜ], which may be generated as a random value.

A secret key used for secret sharing may be expressed by Equation 2 below.

a₀=Pₜ(0) Equation 2

Here, t may be the minimum number of secret sharing key shards necessary for reconstructing a secret key. It may be set to 3 and above. t may be set to be equal to or less than the sum of the number (u) of client devices 13 and that (n) of network devices 15.

Server parameters necessary for distributed authentication may be as follows.

q: Decimal value of modulo operation (u+n<q)

r: Random value for masking secret sharing key shards to be distributed, ( )

p: Decimal value of modulo operation satisfying the conditional expression (p=q*r+1)

Multiplicative group generator of a finite field satisfying the conditional expression

g₁^{r}, g₂^{q}: Secret sharing shard masking parameter, 0

: Validation parameter for distributed secret sharing shards

Next, the secret sharing information management server 11 may generate an information pool that divides a secret key (a₀) into secret sharing shards (S420). Herein, an information pool of the client device 13 and an information pool of the network device 15 may be separately constructed and managed. For example, an information pool of the client device 13 may be constructed by the following operation.

First, the secret sharing information management server 11 may calculate a random value (xᵢ) for secret sharing ID of the i-th client device 13 (S421, refer to FIG. 4B). Herein, ID set (u) of the client device 13 may be expressed as u=u∪xᵢ. In addition, the secret sharing information management server 11 may calculate a secret sharing key (f(x)=Pₜ(xᵢ)) corresponding to secret sharing ID (xᵢ) of each client device 13 (S422). Next, the secret sharing information management server 11 may calculate a secret key (g₁^{rf(xi)}mod p+g₂^{q}) that is masked by g₁^{r} and g₂^{q}(S423).

Likewise, the secret sharing information management server 11 may construct an information pool of a network device by the following operation.

First, the secret sharing information management server 11 may calculate a random value (xⱼ) for secret sharing ID of the j-th network device 15. Herein, a random value (xj) for secret sharing ID may be set to \ddot{|}u (S424, refer to 4C). For this, the secret sharing information management server 11 may calculate a random value (xᵢ) for secret sharing ID of the client device 13 and then a random value (xⱼ) for secret sharing ID of the network device 15. In addition, the secret sharing information management server 11 may calculate a secret sharing key shard (f(xⱼ)=Pₜ(xⱼ)) corresponding to ID (xⱼ) of each network device 13 (S425) and then calculate a secret key (g₁^{rf(xj)}mod p) masked with g₁^{r}(S426).

By the above-described operation, the secret sharing information management server 11 may construct an information pool corresponding to a secret sharing ID (xᵢ) of the client device 13 and an information pool corresponding to a secret sharing ID (xⱼ) of the network device 15.

Referring to FIG. 4A again, the secret sharing information management server 11 may generate and store an initial parameter that is necessary for the network device 15 to verify secret sharing information (S430).

Specifically, the secret sharing information management server 11 may generate t-2 server secret sharing shard sets (S⁻²) to be distributed to the network device 15 and a Lagrange interpolation coefficient (L⁻²) of the server secret sharing shard sets (S⁻²). Server secret sharing shard sets (S⁻²) and a Lagrange interpolation coefficient (L⁻²) may be generated based on Equation 3 and Equation 4 respectively.

$$\begin{matrix}{S}^{- 2} = {S}^{- 2} ⋃ ( \text{?} , \text{?} ) , ( k = 0 to t - 2 , k \neq nj , \text{?} ∈ n , t < ( u + n ) ) & Equation 3 \\ \text{?} = ( {λ}_{0} , \text{?} , … , \text{?} ) = \{ \text{?} \vert \text{?} = \text{?} \frac{\text{?}}{\text{?}} ∈ \text{?} \} \\ \text{?} \text{indicates text missing or illegible when filed} & Equation 4\end{matrix}$$

<Registration of Client Device and Network Device to Secret Sharing Information Management Server>

The client device 13 or the network device 15 may request registration to the secret sharing information management server 11 through a request-response protocol with the secret sharing information management server 11 and may receive a secret sharing key shard as a corresponding response.

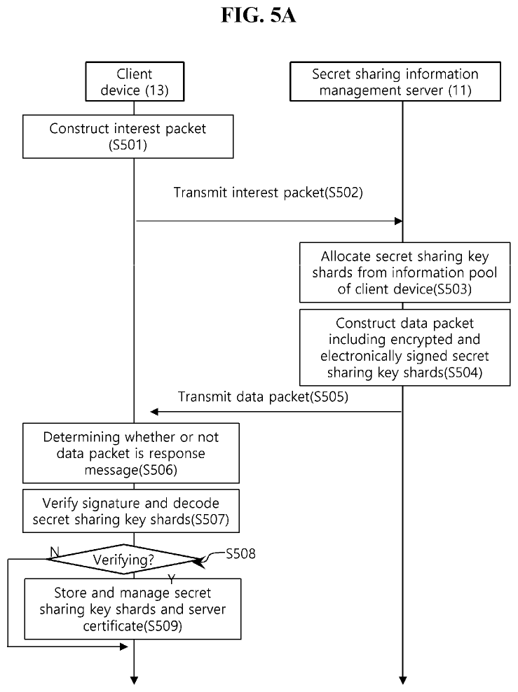

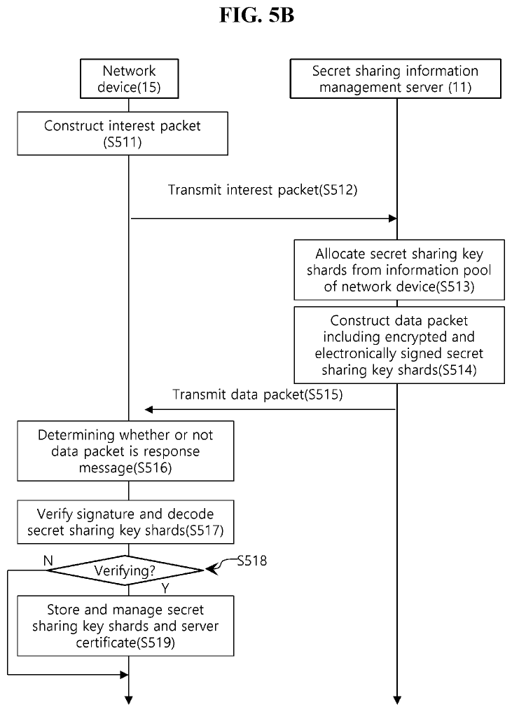

FIG. 5A is a view illustrating an operation of registering a client device, which is installed in a secret sharing authentication system, to a secret sharing information management server, according to an embodiment of the present disclosure. Referring to FIG. 5A, the client device 13 may construct an interest packet by including a request message and a certificate, which are electronically signed (S501), and then transmit the interest packet to the secret sharing information management server 11 (S502). Construction and transmission of an interest packet may be processed based on construction and routing operation of the interest packet in an ICN environment. Here, the interest packet may include the name of the client device 13 or a user, a signature, a user's certificate and the like.

Correspondingly, the secret sharing information management server 11 may allocate secret sharing key shards from an information pool of the client device 13 (S503). In addition, the secret sharing information management server 11 may execute encryption and electronic signature for secret sharing key shards and construct a data packet including encrypted and electronically signed secret sharing key shards (S504). Then, the secret sharing information management server 11 may deliver a data packet as a response to the client device 13 (S505). Correspondingly, the client device 13 may receive the data packet from a network. Here, the data packet may include the name of the client device 13 or a user, signature, a user's certificate and the like.

In the step S506, the client device 13 may distinguish whether or not a data packet received from the secret sharing information management server 11 is a response message. In the step S507, the client device 13 may verify a signature by using a server certificate included in a data packet and may decode an encrypted secret sharing key shard by using a secret key of the client device 13. Then, if a result is judged to be verified in the step S508, the client device 13 may manage and store the secret sharing key shard thus extracted and the server certificate into a secret sharing authentication information DB installed in the client device 13.

FIG. 5B is a view illustrating an operation of registering a network device, which is installed in a secret sharing authentication system, to a secret sharing information management server, according to an embodiment of the present disclosure.

An operation of registering the network device 15 to the secret sharing information management server 13 may be configured in the same manner as the above-described operation of registering the client device 13. Specifically, referring to FIG. 5B, the network device 15 may construct an interest packet by including a request message and a certificate, which are electronically signed (S511), and then transmit the interest packet to the secret sharing information management server 11 (S512).

Correspondingly, the secret sharing information management server 11 may allocate secret sharing key shards from an information pool of the network device 15 (S513). In addition, the secret sharing information management server 11 may execute encryption and electronic signature for secret sharing key shards and construct a data packet including encrypted and electronically signed secret sharing key shards (S514). Then, the secret sharing information management server 11 may deliver a data packet as a response to the network device 15 (S515). Here, the data packet may include the name of the network device 15, an encrypted secret sharing key shard, a signature and a server certificate.

In the step S516, the network device 15 may distinguish whether or not a data packet received from the secret sharing information management server 11 is a response message. In the step S517, the network device 15 may verify a signature by using a server certificate included in a data packet and may decode an encrypted secret sharing key shard by using a secret key of the network device 15. Then, if a result is judged to be normal in the step S518, the network device 15 may manage and store the secret sharing key shard thus extracted and the server certificate into a secret sharing authentication information DB installed in the network device 13.

<Distribution of Secret Sharing Key Shards>

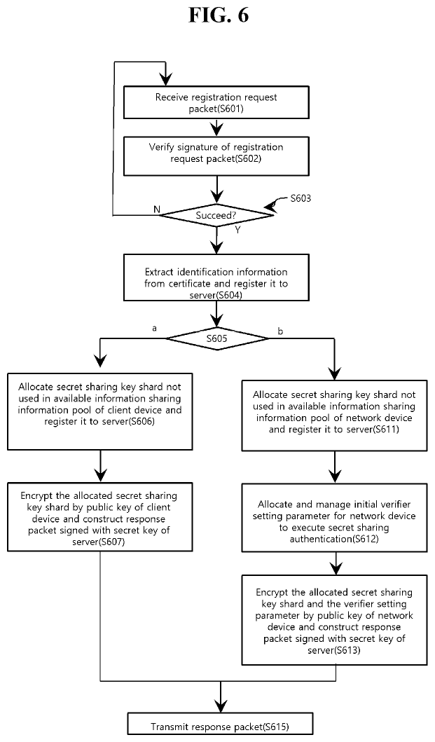

FIG. 6 is a view illustrating that a secret sharing information management server, which is installed in a secret sharing authentication system, distributes secret sharing key shards, according to an embodiment of the present disclosure.

Distributing secret sharing key shards may be a detailed operation of the above-described operations (S503, S513) of allocating secret sharing key shards in an information pool of the client device 13 or the network device 15.

Referring to FIG. 6, the secret sharing information management server 11 may receive a registration request packet from the client device 13 (or the network device 15) (S601). In addition, the secret sharing information management server 11 may verify a signature for the received registration request packet (S602). In case the signature of the registration request packet is successfully verified (S603-Y), identification information may be extracted from a certificate of the client device 13 (or the network device 15) and be registered to the server (S604).

Then, if it is identified as a certificate of the client device 13 (S605-a), the secret sharing information management server 11 may allocate an unused secret sharing key shard from an available secret sharing information pool of the client device 13 to the client device 13, and the secret sharing key shard may be registered and managed in the secret sharing information management server 11 (S606). The secret sharing information management server 11 may encrypt an allocated secret sharing key shard by a public key of the client device 13 and may construct a response packet signed with a secret key of the server 11 (S607).

If it is identified as a certificate of the network device 15 (S605-b), the secret sharing information management server 11 may allocate an unused secret sharing key shard from an available secret sharing information pool of the network device 15 to the network device 15, and the secret sharing key shard may be registered and managed in the secret sharing information management server 11 (S611). Then, the secret sharing information management server 11 may allocate and mange an initial verifier setting parameter that is necessary for a registered network device 15 to execute secret sharing authentication (S612).

In the step S613, the secret sharing information management server 11 may encrypt an allocated secret sharing key shard and a verifier setting parameter for a network device 15 by a public key of the network device 15 and may construct a response packet signed with a secret key of the server 11 (S614).

In the step S615, the server may transmit a registration response packet, which is generated in the step S607 or S614, to the client device 13 or the network device 15.

<Initial Setting for Threshold Secret Sharing Authentication of Network Device>

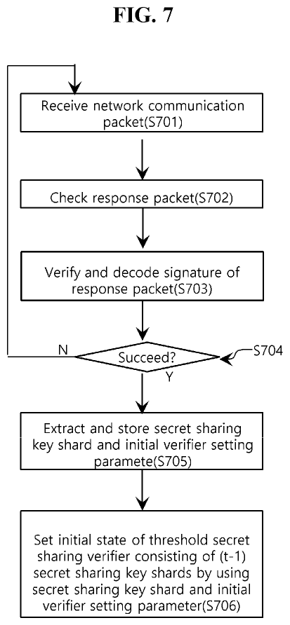

As described in the configuration of the secret sharing authentication system 10, the network device 15, which processes a verifying operation by using information received from the secret sharing information management server 11, may calculate and mange a necessary parameter for verification through an initial setting operation in advance. Hereinafter, an initial setting operation of a network device will be described with reference to FIG. 7.

FIG. 7 is a view illustrating that a network device installed in a secret sharing authentication system sets defaults for threshold secret sharing authentication according to an embodiment of the present disclosure.

Referring to FIG. 7, in the step S701, the network device 15 may receive a network communication packet.

In the step S702, the network device 15 may distinguish whether or not a received packet is a response packet at a service registration request of the network device 15.

In the step S703, the network device 15 may verify a signature of a response packet by using a server certificate received along with a message and may also decode the response packet by using a secret key of the network device 15.

In the step S704, when decoding is normally executed, the network device 15 may extract a secret sharing key shard (<xₙⱼ, g₁^{rf(x}^{ₙⱼ₎}>) of the device and an initial verifier setting parameter from a received packet and then may store and manage them in a secret sharing authentication information DB for the device (S705). Here, an initial setting parameter may include (t-1) secret sharing key shard sets (refer to Equation 5), calculations of (t-2) Lagrange interpolation coefficients reflecting secret sharing key shards of a network device (refer to Equation 6), and calculations of (t-1) Lagrange interpolation coefficients including the network device (refer to Equation 7).

$$\begin{matrix} {S}^{- 1} = {S}^{- 2} ⋃ < {x}_{nj} , {g}_{1}^{rf ( {x}_{nj} )} > & Equation 5 \\ {λ}_{l}^{- 2} = {λ}_{l}^{- 2} \times \frac{\text{?}}{\text{?}} , ( 0 \leq l \leq t - 2 ) , ( ∀ {λ}_{l}^{- 2} ∈ {Λ}^{- 2} ) & Equation 6 \\ {Λ}^{- 2} = ( {λ}_{0} , {λ}_{1} , … , \text{?} , \text{?} ) = ( \text{?} \vert \text{?} = \text{?} \frac{{x}_{l}}{\text{?}} \\ \text{?} \text{indicates text missing or illegible when filed} & Equation 7\end{matrix}$$

In the step S706, the network device 15 may set an initial state of a threshold secret sharing verifier consisting of (t-1) secret sharing key shards by using secret sharing key shards and an initial verifier setting parameter, which are extracted in the step S705.

<Secret Sharing Authentication Token Construction of Client Device>

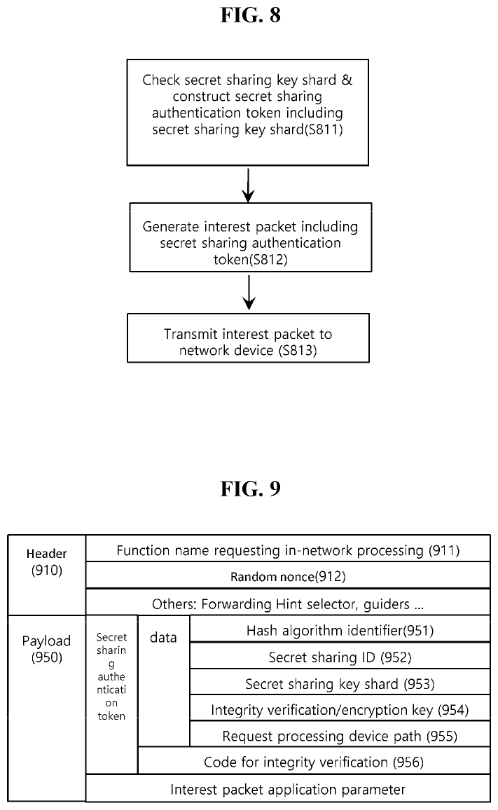

FIG. 8 is a view illustrating that a client device installed in a secret sharing authentication system requests an in-network processing service by using a secret sharing authentication token, according to an embodiment of the present disclosure.

Referring to FIG. 8, in the step S811, the client device 13 may identify a secret sharing key shard allocated from a secret sharing authentication information DB, which is installed in the client device 13, and may construct a secret sharing authentication token including the identified secret sharing key shard. In addition, the client device 13 may generate an interest packet including a secret sharing authentication token (S812). Here, the interest packet 900 (refer to FIG. 9) may include a header 910 and a payload 950. The header 910 may include network forwarding parameters like a function name 911 requesting in-network processing, a random nonce 912. The payload 950 may include a secret sharing authentication token. A secret sharing authentication token may include an identifier 951 of a hash algorithm used for generating and verifying a message integrity verification code, a secret sharing ID 952 necessary for authentication of a client device, a secret sharing key shard 953, a random key 954 for integrity verification and encryption, which is masked with g^{ra0}, a request processing device path 955 including in-network requests and computational chain information of processing devices, and a code 956 for verifying the integrity of a secret sharing authentication token 950.

Furthermore, while a secret sharing authentication token is constructed, the client device 13 may generate an encryption key (kᵤᵢ) (for example, a random value) for message integrity verification between the client device 13 and the network device 15 and also execute masking for the encryption key (kᵤᵢ) by using a masked secret key. Thus, the client device may construct the random key 954 for integrity verification and encryption, as expressed by Equation 8 below.

τ=kᵤᵢg₁^{ra}₀ Equation 8

In addition, the client device 13 may add its identifier to an interest packet processing path 955 {PⱼHash(<xᵤᵢ,g₁^{rf(xui)}+g₂^{q}>}. Based on this, such an ID may be used to identify a path of a device where an interest packet is processed.

Then, the client device 13 may transmit an interest packet to a network device (S813). <In-Network Processing Service Request and Response Using Secret Sharing Authentication Token>

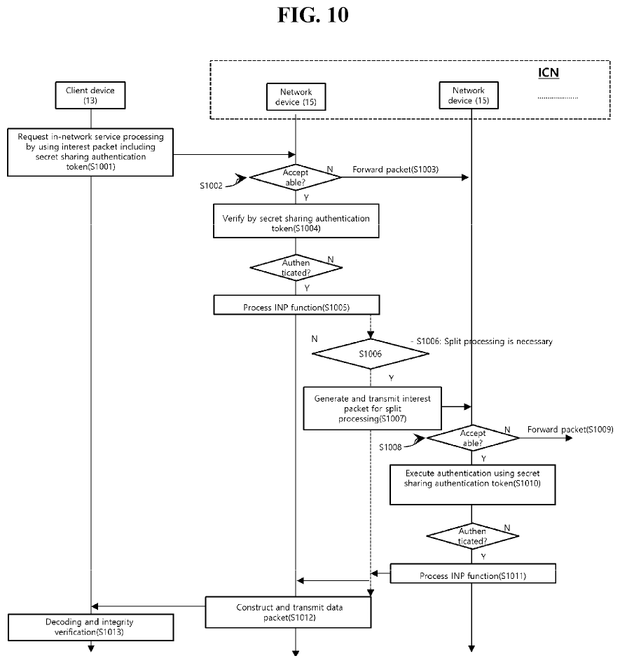

FIG. 10 is a view illustrating that an in-network processing service is requested and processed by using a secret sharing authentication token, according to an embodiment of the present disclosure.

Referring to FIG. 10, in the step 51001, the client device 13 may request in-network service processing by using an interest packet including a secret sharing authentication token.

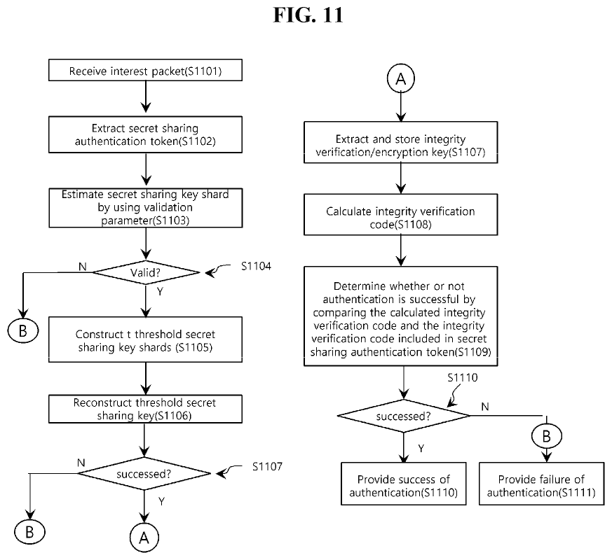

After receiving an interest packet, the network device 15 judges whether or not it is acceptable by using information included in the header of the interest packet (S1002). In case it is not acceptable, the network device 15 forwards the packet (S1003). On the other hand, if it is acceptable in the step S1002, the network device 15 may execute authentication using a secret sharing authentication token (S1004). Authentication using a secret sharing authentication token will be described in detail by referring to FIG. 11 below.

When authentication is succeeded in the step S1004, the network device 15 may process an in-network processing request function based on information included in the header of an interest packet (S1005). Here, if a calculation function execution code or input data of a function is required for processing a request function, a request may be sent to and a response may be received from a calculation function provider or a calculation data provider.

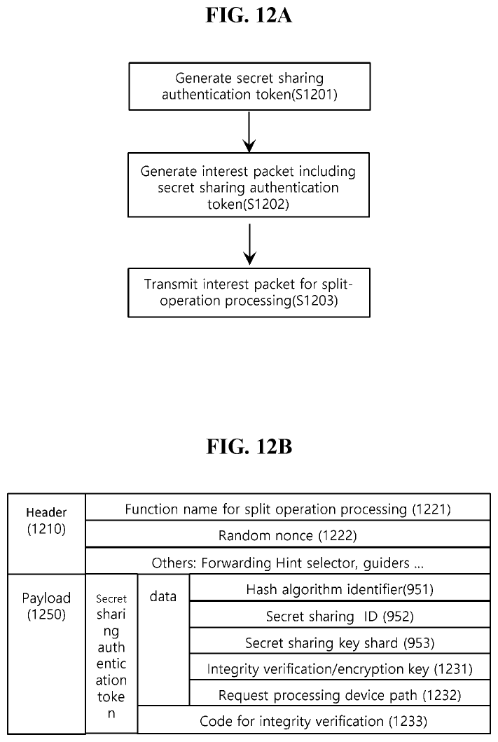

Furthermore, in the step S1005, if split processing of a calculation function is necessary (S1006-Y), a current network device 15 may generate and transmit an interest packet processing request to another network device (15′) (S1007). A detailed operation of constructing and transmitting an interest packet will be described in detail with reference to FIG. 12 below.

Meanwhile, another network device (15′) receiving an interest packet may judge whether or not it is acceptable (S1010) and execute authentication (S1010) and in-network processing (S1011), like in the steps S1002, S1004 and S1005.

In the step S1012, the network device 15 may encrypt a processing result of the step S1005 or the step S1011 by using an encryption key and may respond to a user by constructing a data packet.

In the step S1013, after receiving an encrypted response data packet for an in-network processing request, the client device 13 may decode it by an encryption key and verify its integrity.

<Authentication Using Secret Sharing Authentication Token in Network Device>

FIG. 11 is a view illustrating an authentication operation where a network device installed in a secret sharing authentication system uses a secret sharing authentication token, according to an embodiment of the present disclosure.

As a secret sharing authentication method can reconstruct a secret key (g₁^{ra0}) only when the number of secret shards, which can be known, is equal to or greater than a predetermined threshold (t), a verifier should verify whether or not a user has one of valid secret sharing shards (952, 953) necessary for reconstructing the secret key. In a secret sharing authentication system according to an embodiment of the present disclosure, a network device may function as a verifier. Hereinafter, a network device functioning as a verifier will be referred to as a verifier.

In the steps S1101 and S1102, a verifier may receive an interest packet and extract a secret sharing authentication token. Herein, a secret sharing authentication token may include a user's secret sharing key shards. Since a user's secret sharing key shards are distributed after being double-masked by a server with the intent of preventing a secret key from being leaked by the user's conspiracy, a verifier of a network device unmasks them into recognizable secret key shards by using Equation 9 before authentication.

g₁^{rf(x}^{ᵤᵢ}⁾=((g₁^{rf(x}^{ᵤᵢ}⁾mod p+g₂^{q})−1)mod p Equation 9

In the step S1103, a verifier may calculate a secret sharing key shard for a secret sharing ID (952)=xᵤᵢ, of a user (or a client network device in the case of split operation) by using a validation parameter (a dividend of division p, C=(g₁^{ra0}, g₁^{ra1}, g₁^{rat}), which is provided as an initial setting parameter from a secret sharing information management server, as expressed in Equation 10.

$$S = \text{?} ( \text{?} ) ( \text{?} ) … ( \text{?} ) mod p , j = \text{?} \\ \text{?} \text{indicates text missing or illegible when filed} \qquad Equation 10$$

In the step S1104, it may be checked whether or not a secret sharing key shard (g₁^{rf(xui)}953) extracted in the step S1102 is the same as the value of S′ calculated in the step S1103. Thus, <secret sharing ID, secret sharing key shard> of a user (or a network client device) may be identified, and whether or not it is issued by a secret sharing information management server may be verified.

In the step S1105, a verifier may construct t threshold secret sharing key shards by merging one secret shard <secret sharing ID, secret sharing key shard> of a user or a client device and (t-1) secret sharing key shards that are initially set. In addition, a verifier may reconstruct a calculated threshold sharing secret key (δ) by using the Lagrange interpolation.

In the step S1106, the threshold sharing secret key (δ) that is reconstructed in the step S1105 may be compared with a secret key (g₁^{ra0}) received from a secret sharing information management server. Thus, it may be checked whether or not they are identical. Accordingly, a verifier may verify that a client device has a proved secret sharing shard, thereby judging whether or not authentication is succeeded or fails.

In the step S1107, a verifier may extract an integrity verification/encryption key 954 included in a secret sharing authentication token 750 by using a calculation of δ obtained in the step S1106, as expressed in Equation 11 below. The integrity verification/encryption key may be stored and managed in the verifier, that is, a network device.

$${k}_{ui} = \frac{Y}{δ} = \frac{{k}_{ui} \cdot {g}^{{ra}_{0}}}{{g}^{r {a}_{0}}} \qquad Equation 11$$

In the step S1108, an integrity verification code may be calculated by using the integrity verification/encryption key (=kᵤᵢ) 954 extracted in the step S1107, as expressed in Equation 12 below.

Equation 12

mac′ᵤᵢ=Hash(Kᵤᵥ Function name (911), Random nonce (912), Secret sharing authentication token data (951˜955))

In the step S1109, a verifier may compare an integrity verification code (mac′ᵤᵢ) calculated in the step S1108 and an integrity verification code (mac) 956 included in a secret sharing authentication token 950. Thus, it may be checked whether or not the secret sharing authentication token 950 is reused by an attacker, and the success or failure of authentication may be ultimately determined.

<Interest Packet Construction and Transmittance for Split-Operation Processing in Network Device>

FIG. 12A is a view illustrating that a network device, which is installed in a secret sharing authentication system, constructs and transmits an interest packet for split-operation, according to an embodiment of the present disclosure. FIG. 12B is a view illustrating an interest packet generated by the operation of FIG. 12A.

As described above, the construction and transmittance of an interest packet illustrated in FIG. 12 is necessary for a current network device (for example, a first network device) to request processing to another network device (for example, a second network device), when split processing of a calculation function is required for function processing.

In the steps S1201 and S1202, an operation processor of a network device may generate an interest packet and a secret sharing authentication token for split operation.

In the step S1202, since a split operation processing request is made to execute in-network processing requested by a client device, a secret sharing ID 952 and a secret sharing key shard 953, which are included in a secret sharing authentication token 950, may include an initial user's information.

On the other hand, since integrity verification or an operation connection chain between processing devices is made between a first network device (xₙⱼ) and a second network device (xₙₖ), an integrity verification/encryption key ( ) 1231 may be generated and constructed randomly by the first network device. Here, the integrity verification/encryption key 1231 generated by the first network device may be constructed as shown in Equation 13 below.

τ=kₙⱼg₁^{ra}₀ Equation 13

A request processing device path value 1232 of a secret sharing authentication token may be generated by adding a secret sharing ID (xₙⱼ) of a first network device to a request processing device path (xᵤᵢ) that is generated by an initial user or a client device. For example, it may be generated by Equation 14 below.

P={Hash(<xᵤᵢ,g₁^{rf(x}^{ᵤᵢ}⁾⁺g₂^{q}>{∥Hash(<xₙⱼ,g₁^{rf(x}^{ₙⱼ}⁾>} Equation 14

In addition, a first network device may generate a hash result, which is obtained by inputting a split operation processing function name 1221, a random nonce 1222, data of a corresponding secret sharing authentication token 951, 952, 953, an integrity verification/encryption key 1231 and a request processing device path 1232, as a message integrity verification code 1233 of the secret sharing authentication token.

Meanwhile, in the step S1203, a first network device may send an interest packet 1200 constructed through the above-described operation, that is, an interest packet 1200 for split-operation processing.

<Operation (or Split Operation) Response Data Packet Processing in Network Device>

As described above, when split processing of a calculation function is required for function processing, the construction and transmittance of an interest packet illustrated in FIG. 12 may be necessary for a current network device (for example, a first network device) to request processing to another network device (for example, a second network device), and the second network device may execute split operation and respond to the first network device by transmitting the result.

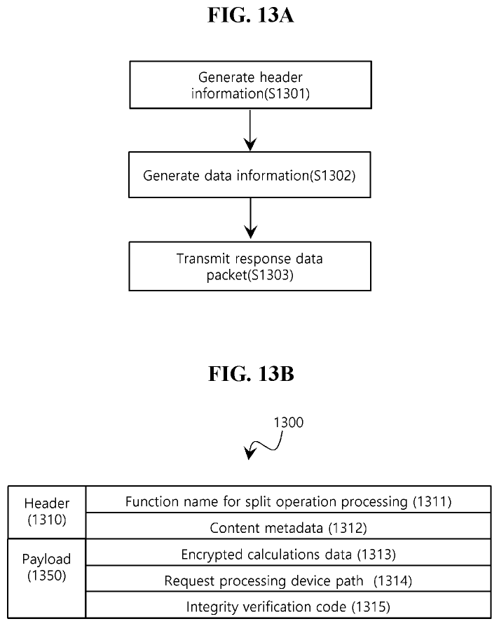

Hereinafter, referring to FIG. 13, an operation of a second network (or a first network) device responding to a first network (or a user client) device by a result of split operation will be described.

FIG. 13A is a view illustrating that a network device, which is installed in a secret sharing authentication system, sends a split operation result, according to an embodiment of the present disclosure. FIG. 13B is a view illustrating a response data packet generated by the operation of FIG. 13A.

First, referring to FIG. 13A, in the steps S1301 and S1302, in the case of split-operation processing, an operation processor of a second network device (or a first network device, otherwise) may generate a response data packet 1300 that is encrypted from processing result data. Specifically, in the step S1301, header information 1310 (request function name 1311 (refer to FIG. 13B)) according to a data packet type of ICN (for example, a named data networking packet format) and content meta information 1312 may be generated.

In the step S1302, a second network device may generate encrypted operation result data 1313 and an integrity verification code 1315 for a response message by fetching a secret key (k) stored inside. In addition, in order to render the traceability of an in-network operation processing chain, a second network device may generate a request processing device path 1314 P={Hash(<xᵤᵢ,g₁^{rf(xui)}+g₂^{q}>}∥Hash(<xₙⱼ,g₁^{rf(xnj)}>∥Hash(<xₙₖ,g₁^{rf(xnk)}>}, to which a secret sharing ID of the second network device is added.

In the step S1303, a second network device may transmit a response data packet 1310 including in-network processing result to a requester, that is, a first network device (xₙⱼ). (If not split-operation processing, as described above, a first network device (xₙⱼ) may transmit it to a user client device (xᵤᵢ).)

According to the present disclosure, a method and apparatus for securing a cryptographic authentication means with characteristics of “1-way authentication, dynamic sharing authentication, low-delay local authentication, split operation-connected authentication”, without depending on a centralized authentication server and maintaining user information (DB) at network nodes.

According to the present disclosure, a method and apparatus for minimizing communication service delay and preventing an unauthorized user from illegally occupying or abusing computing resources may be provided, as in-network distributed processing devices may internally perform user authentication immediately after the receipt of a packet.

Effects obtained in the present disclosure are not limited to the above-mentioned effects, and other effects not mentioned above may be clearly understood by those skilled in the art from the following description.

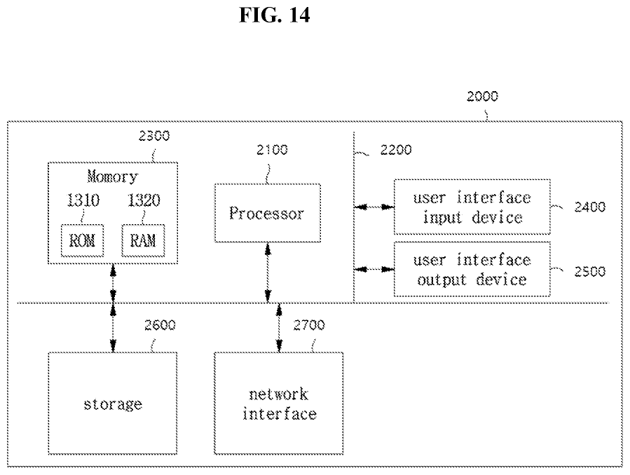

FIG. 14 is a block diagram illustrating a computing system for executing an apparatus and method for processing information of multiple cameras and an apparatus and method for a secret sharing authentication according to an embodiment of the present disclosure.

Referring to FIG. 14, a computing system 2000 may include at least one processor 2100 connected through a bus 1200, a memory 2300, a user interface input device 2400, a user interface output device 1500, a storage 1600, and a network interface 2700. The processor 2100 may be a central processing unit or a semiconductor device that processes commands stored in the memory 2300 and/or the storage 2600. The memory 2300 and the storage 2600 may include various volatile or nonvolatile storing media. For example, the memory 2300 may include a ROM (Read Only Memory) and a RAM (Random Access Memory).

Accordingly, the steps of the method or algorithm described in relation to the embodiments of the present disclosure may be directly implemented by a hardware module and a software module, which are operated by the processor 2100, or a combination of the modules. The software module may reside in a storing medium (that is, the memory 2300 and/or the storage 2600) such as a RAM memory, a flash memory, a ROM memory, an EPROM memory, an EEPROM memory, a register, a hard disk, a detachable disk, and a CD-ROM. The exemplary storing media are coupled to the processor 2100 and the processor 2100 can read out information from the storing media and write information on the storing media. Alternatively, the storing media may be integrated with the processor 2100. The processor and storing media may reside in an application specific integrated circuit (ASIC). The ASIC may reside in a user terminal. Alternatively, the processor and storing media may reside as individual components in a user terminal.

The exemplary methods described herein were expressed by a series of operations for clear description, but it does not limit the order of performing the steps, and if necessary, the steps may be performed simultaneously or in different orders. In order to achieve the method of the present disclosure, other steps may be added to the exemplary steps, or the other steps except for some steps may be included, or additional other steps except for some steps may be included.

Various embodiments described herein are provided to not arrange all available combinations, but explain a representative aspect of the present disclosure and the configurations about the embodiments may be applied individually or in combinations of at least two of them. Further, various embodiments of the present disclosure may be implemented by hardware, firmware, software, or combinations thereof When hardware is used, the hardware may be implemented by at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), a general processor, a controller, a micro controller, and a micro-processor.

The scope of the present disclosure includes software and device-executable commands (for example, an operating system, applications, firmware, programs) that make the method of the various embodiments of the present disclosure executable on a machine or a computer, and non-transitory computer-readable media that keeps the software or commands and can be executed on a device or a computer.

What is claimed is:

1. A system for a secret sharing authentication comprising:
a secret sharing information management server configured to store and manage a secret key capable of being used for secret sharing authentication by dividing the secret key into a first secret sharing key shard and a second secret sharing key shard, and to allocate the first and second secret sharing key shards;
a client device configured to receive and manage the first secret sharing key shard allocated from the secret sharing information management server and to construct an interest packet by using the first secret sharing key shard; and
a network device configured to receive and manage the second secret sharing key shard allocated from the secret sharing information management server, to process the interest packet received from the client device on the basis of an ICN (Information Centric Networking) method, and to perform secret sharing authentication by using the second secret sharing key shard and the first secret sharing key shard comprised in the interest packet.

2. The system of claim 1,
wherein the client device generates a secret sharing authentication token comprised in the interest packet, and
wherein the secret sharing authentication token comprises at least one of a hash algorithm identifier, a secret sharing ID necessary for authenticating the client device, the first secret sharing key shard, an integrity verification and encryption key, a request processing device path, and a code for verifying the integrity of the secret sharing authentication token.

3. The system of claim 1,
wherein the network device executes authentication
by checking the first secret sharing key shard comprised in the secret sharing authentication token,
by estimating the first secret sharing key shard through a validation parameter, and
by comparing the estimated first secret sharing key shard and the first secret sharing key shard comprised in the secret sharing authentication token.

4. The system of claim 4,
wherein the network device constructs t threshold secret sharing key shards by merging the authenticated first secret sharing key shard and the (t-1) second secret sharing key shards that are initially set.

5. The system of claim 4,
wherein the network device reconstructs a threshold sharing secret key through interpolation using the t threshold secret sharing key shards and verifies the threshold sharing secret key by comparing a secret key received from the secret sharing information management server and the reconstructed secret key.

6. The system of claim 5,
wherein the network device extracts an integrity verification and encryption key comprised in the secret sharing authentication token and a first integrity verification code,
generates a second integrity verification code by using the integrity verification and encryption key, and
verifies the secret sharing authentication token by comparing the first integrity verification code and the second integrity verification code.

7. The system of claim 2,
wherein the network device comprises a first network device and a second network device, and
wherein the first network device requests split processing of a calculation function to the second network device.

8. The system of claim 7,
wherein the first network device constructs a secret sharing authentication token for split processing and generates the interest packet comprising the secret sharing authentication token for split processing.

9. The system of claim 8,
wherein the secret sharing authentication token for split processing comprises
a secret sharing ID necessary for authenticating the client device, the first secret sharing key shard, an auxiliary integrity verification and encryption key generated by the first network device, and an auxiliary integrity verification code generated by the auxiliary integrity verification and encryption key.

10. The system of claim 8,
wherein, in response to the receipt of the interest packet from the network device, the second network device processes the calculation function on the basis of information comprised in the interest packet, generates a response data packet comprising the processed calculation result, and transmits the generated response data packet to the first network device.

11. The system of claim 10,
wherein the second network device encrypts the calculation result by using a secret key stored in the second network device.

12. The system of claim 1,
wherein the secret sharing information management server sets a server parameter necessary for performing split authentication, and
wherein the server parameter comprises at least one of an arbitrary random value for masking the secret sharing key shard, a multiplier group generator of field, a modulo operation decimal value, a masking parameter of the secret sharing key shard, and a validation parameter of the secret sharing key shard.

13. The system of claim 1,
wherein the secret sharing information management server
receives a registration request packet from the client device,
performs verification for a signature of the registration request packet,
processes registration by checking identification information of the client device,
allocates the secret sharing key shard from an available secret sharing information pool of the client device,
encrypts the secret sharing key shard into a public key of the client device, and
constructs the encrypted data into a response packet signed with a secret key of the secret sharing information management server.

14. The system of claim 1,
wherein the secret sharing information management server
receives a registration request packet from the network device,
performs verification for a signature of the registration request packet,
processes registration by checking identification information of the network device,
allocates the secret sharing key shard from an available secret sharing information pool of the network device,
encrypts the secret sharing key shard into a public key of the network device, and
constructs the encrypted data into a response packet signed with a secret key of the secret sharing information management server.

15. The system of claim 1,
wherein the network device
transmits a service registration request packet to the secret sharing information management server,
receives a response packet from the secret sharing information management server,
verifies a signature of the response packet by using a certificate of the secret sharing information management server,
decodes the response packet by using a secret key of the network device, and
checks and stores a secret sharing key shard of the network device and an initial verifier setting parameter comprised in the response packet.

16. The system of claim 15,
wherein, based on t secret sharing key shards obtained by dividing a secret key, the initial setting parameter comprises at least one among (t-1) secret sharing key shard sets, calculations of (t-2) Lagrange interpolation coefficients, and calculations of (t-1) Lagrange interpolation coefficients comprising the network device.

17. A method for a secret sharing authentication, the method comprising;
masking, by a secret sharing information management server configured to split and manage a secret key used for secret sharing authentication, a first secret sharing key shard and providing the first secret sharing key shard to a client device and providing a second secret sharing key shard to a network device,
constructing, by the client device, an interest packet by using the first secret sharing key shard and transmitting the interest packet to the network device based on an information centric networking (ICN) method, and
processing, by the network device, the interest packet based on the ICN method by unmasking the first secret sharing key shard comprised in the interest packet, and by performing secret sharing authentication by using the unmasked first secret sharing key shards and the second secret sharing key shard.

18. The method of claim 17,
wherein the transmitting of the interest packet to the network device comprises generating a secret sharing authentication token comprised in the interest packet, wherein the secret sharing authentication token comprises at least one among a hash algorithm identifier, a secret sharing ID necessary for authenticating the client device, the first secret sharing key shard, an integrity verification and encryption key, a request processing device path, and a code for verifying the integrity of the secret sharing authentication token.

19. The method of claim 17,
wherein the performing of secret sharing authentication comprises:
determining the first secret sharing key shard comprised in the secret sharing authentication token,
estimating the first secret sharing key shard by using a validation parameter, and
comparing the estimated first secret sharing key shard and the first secret sharing key shard comprised in the secret sharing authentication token.
